(19) United States
(12) Patent Application Publication
(10) Pub. No.: US 2020/0201515 A1
(43) Pub. Date: Jun. 25, 2020

(54) METHOD AND ELECTRONIC DEVICE FOR CONTROLLING AUGMENTED REALITY DEVICE

(71) Applicant: Samsung Electronics Co., Ltd., Suwon-si (KR)

(72) Inventors: Choonkyoung MOON, Suwon-si (KR); Jueun LEE, Suwon-si (KR); Shinjae JUNG, Suwon-si (KR)

(21) Appl. No.: 16/719,163

(22) Filed: Dec. 18, 2019

(30) Foreign Application Priority Data
Dec. 19, 2018 (KR) 10-2018-0165566

(51) Int. Cl. G06F 3/0481; G06F 3/01; G06F 3/0488; G06F 3/0354; G06T 19/00; G06K 9/00; G02B 27/01

(52) U.S. Cl. CPC G06F 3/04815; G06F 3/017; G06F 3/0488; G02B 27/017; G06T 19/006; G06K 9/00671; G06F 3/03547

(57) ABSTRACT

An electronic device is provided including a touch screen display, a communication module configured to communicate with an augmented reality device, a memory, and at least one processor. The memory stores instructions that, when executed by the at least one processor, cause the at least one processor to identify a connection state with the augmented reality device through the communication module, detect an input event to the touch screen display while in a connected state with the augmented reality device, analyze the detected input event, according to a result of the analysis, determine whether the input event is intended for at least one of a first screen based on the touch screen display or a second screen corresponding to a virtual screen produced by the augmented reality device, and perform a function corresponding to the input event with respect to at least one of the first screen or the second screen.

### CROSS-REFERENCE TO RELATED APPLICATION(S)

This application is based on and claims priority under 35 U.S.C. § 119(a) of a Korean patent application number 10-2018-0165566, filed on Dec. 19, 2018, in the Korean Intellectual Property Office, the disclosure of which is incorporated by reference herein in its entirety.

### BACKGROUND

### 1. Field

The disclosure relates to a method of controlling an augmented reality device and an electronic device performing the same. More particularly, the disclosure relates to control of an augmented reality device in response to an input to a display of an electronic device.

### 2. Description of Related Art

Some electronic devices are provided so as to be wearable on a user's body. Such electronic devices are typically called “wearable devices” and may be provided so as to be mounted to a specific part of the body (e.g., a head, a wrist, fingers, eyes, a waist, etc.). The wearable device may be worn on a body, thereby increasing portability and accessibility.

The wearable device may include an augmented reality (AR) device (e.g., AR glasses) that provides augmented reality to a user. The augmented reality device may include a semi-transparent lens, and may provide a virtual screen to the user, based on the semi-transparent lens. The augmented reality device may implement a virtual screen by synthesizing and combining virtual objects or things, based on the real world, and may provide additional information to the user through the virtual screen.

The above information is presented as background information only to assist with an understanding of the disclosure. No determination has been made, and no assertion is made, as to whether any of the above might be applicable as prior art with regard to the disclosure.

### SUMMARY

Although the augmented reality device is able to show at least one content to a user through a virtual screen, this may make it difficult for the user to directly control the at least one content. For example, if the user makes a gesture input within a preset space in order to control the content displayed on the virtual screen, the augmented reality device may recognize the gesture input. However, it is technically difficult for the augmented reality device to accurately recognize the gesture input within a preset space, and the accuracy may be low. In particular, if the user wishes to perform a precise operation on the at least one content, it may be difficult to accurately reflect the intention of the user.

Aspects of the disclosure are to address at least the above-mentioned problems and/or disadvantages and to provide at least the advantages described below. Accordingly, an aspect of the disclosure is to provide an electronic device that may be functionally connected to an augmented reality device, and may be provided to a user as an input device for the augmented reality device.

Additional aspects will be set forth in part in the description which follows and, in part, will be apparent from the description, or may be learned by practice of the presented embodiments.

In accordance with an aspect of the disclosure, an electronic device is provided. The electronic device includes a touch screen display, a communication module configured to communicate with an augmented reality device, a memory, and at least one processor operably connected to the touch screen display, the communication module, and the memory. The memory stores instructions that, when executed by the at least one processor, cause the processor to identify a connection state with the augmented reality device through the communication module, detect an input event to the touch screen display while in a connected state with the augmented reality device, analyze the detected input event, according to a result of the analysis, determine whether the input event is intended for at least one of a first screen based on the touch screen display or a second screen corresponding to a virtual screen produced by the augmented reality device, and perform a function corresponding to the input event with respect to at least one of the first screen or the second screen.

In accordance with another aspect of the disclosure, a method for operating an electronic device is provided. The method includes identifying a connection state with the augmented reality device, detecting an input event to the touch screen display while in a connected state with the augmented reality device, analyzing the detected input event, according to a result of the analysis, determining whether the input event is intended for at least one of a first screen based on the touch screen display or a second screen corresponding to a virtual screen produced by the augmented reality device, and performing a function corresponding to the input event with respect to at least one of the first screen or the second screen.

An electronic device according to various embodiments can be functionally connected to an augmented reality device, and can control, at least in part, the augmented reality device, based on the electronic device. For example, an augmented screen displayed through the augmented reality device can be adjusted by means of the electronic device. An electronic device according to various embodiments can analyze a user input through a touch screen, can determine that the user input corresponds to an augmented screen, and can control at least one content displayed on the augmented screen in response to the determined user input. An electronic device can provide a variety of information to the user, thereby increasing the convenience of using the augmented reality device. In addition, various effects that are directly or indirectly recognized through this document may be provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a diagram illustrating the communication state between an electronic device, an augmented reality device, and a server according to an embodiment of the disclosure;

FIG. 3 is a block diagram illustrating an electronic device and an augmented reality device according to an embodiment of the disclosure;

FIG. 4A is a flowchart illustrating a method of controlling an augmented reality device in an electronic device according to an embodiment of the disclosure, and

FIG. 4B is a flowchart illustrating a method of controlling an augmented reality device in an electronic device according to an embodiment of the disclosure;

FIG. 5 is a diagram illustrating the operation of an electronic device and an augmented reality device in response to an input event according to an embodiment of the disclosure;

FIG. 6A is a diagram illustrating a process of transmitting and receiving data between an electronic device and an augmented reality device according to an embodiment of the disclosure, and FIG. 6B is a diagram illustrating a process of transmitting and receiving data between an electronic device and an augmented reality device according to an embodiment of the disclosure;

FIG. 7 is a diagram illustrating a screen provided to a user, based on an electronic device and an augmented reality device according to embodiment of the disclosure;

FIG. 8A is a diagram illustrating an embodiment of controlling, at least in part, an augmented reality device using an electronic device according to an embodiment of the disclosure, and FIG. 8B is a diagram illustrating an embodiment of controlling, at least in part, an augmented reality device using an electronic device according to an embodiment of the disclosure; and

FIG. 9A is a diagram illustrating an embodiment of displaying a screen by an augmented reality device using an electronic device according to an embodiment of the disclosure, and FIG. 9B is a diagram illustrating an embodiment of displaying a screen by an augmented reality device using an electronic device according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

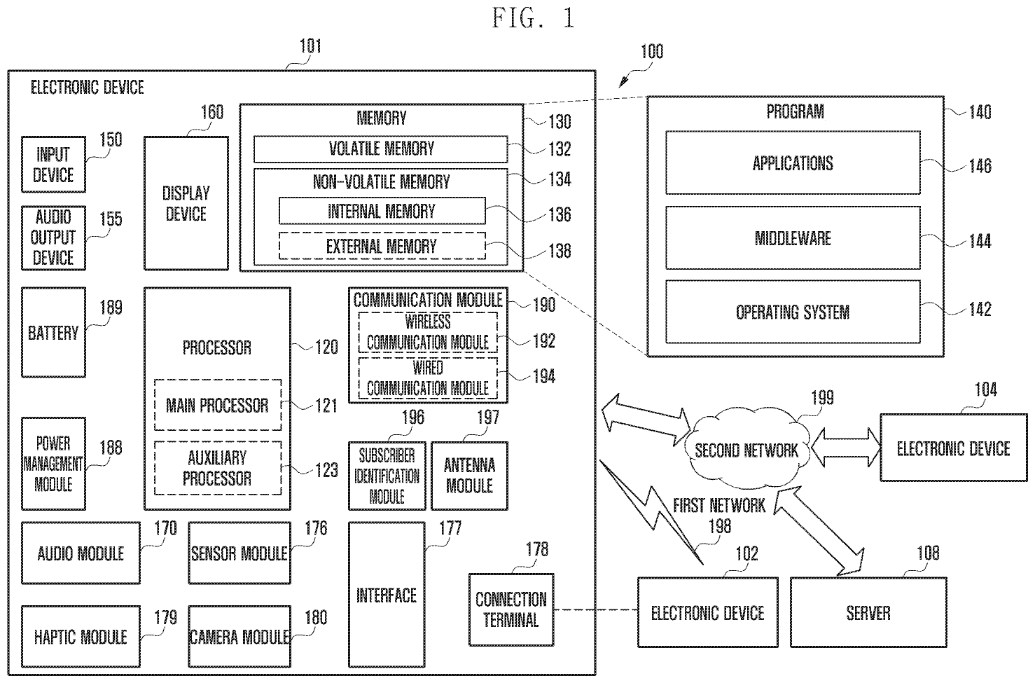

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, an audio output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 (e.g., dynamic random access memory (DRAM), static RAM (SRAM) or synchronous dynamic RAM (SDRAM)) may include the volatile memory 132 or the non-volatile memory 134.

The program 140 may be stored in the memory 130 as software, and may include, for example, an operating system (OS) 142, middleware 144, or an application 146 (e.g., application program).

The input device 150 may receive a command or data to be used by another component (e.g., the processor 120) of the electronic device 101, from the outside (e.g., a user) of the electronic device 101. The input device 150 may include, for example, a microphone, a mouse, or a keyboard.

The audio output device 155 may output sound signals to the outside of the electronic device 101. The audio output device 155 may include, for example, a speaker or a receiver. The speaker may be used for general purposes, such as playing multimedia or playing record, and the receiver may be used for an incoming call. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the audio output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector),

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include one or more antennas, and, therefrom, at least one antenna appropriate for a communication scheme used in the communication network, such as the first network 198 or the second network 199, may be selected, for example, by the communication module 190 (e.g., the wireless communication module 192). The signal or the power may then be transmitted or received between the communication module 190 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101.

According to an embodiment, the electronic device 102 or 104 may include an augmented reality (AR) device. According to an embodiment, the electronic device 101 may transmit and receive data to and from the augmented reality device through the communication module 190.

According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

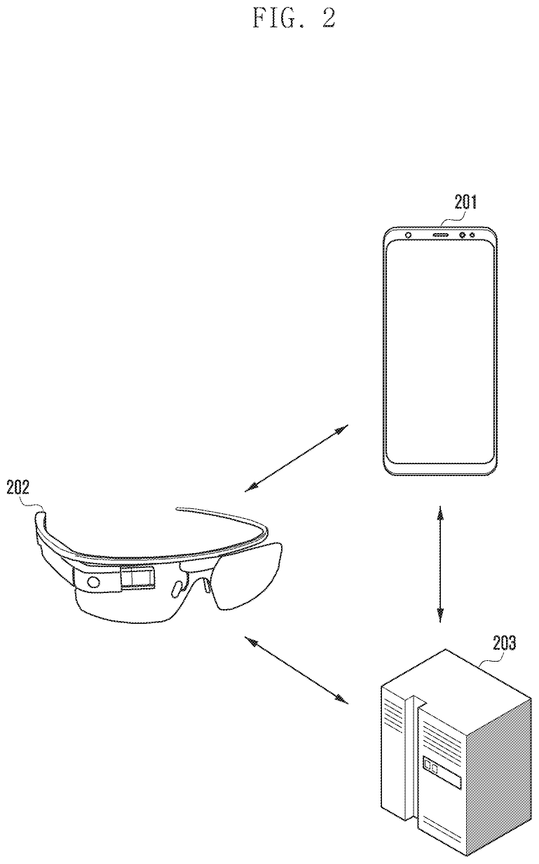

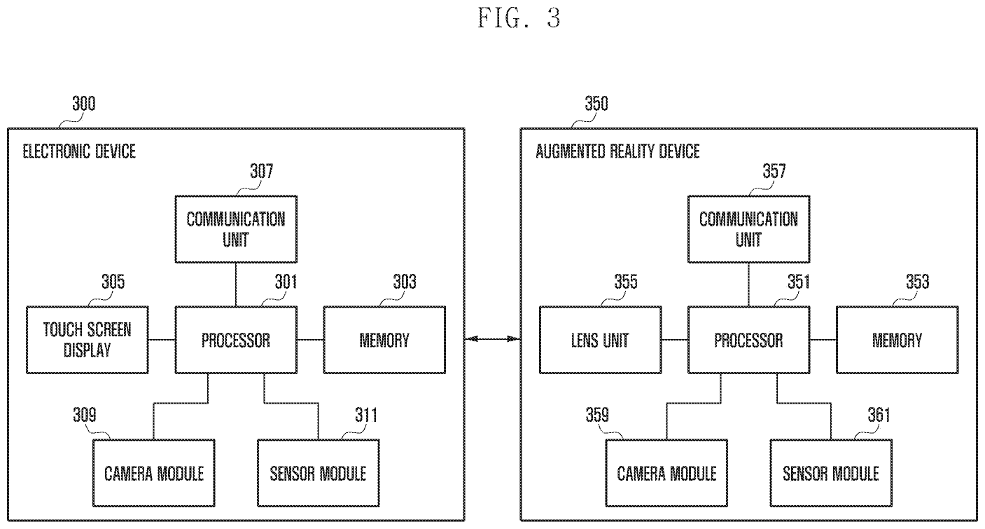

FIG. 2 is a diagram illustrating the communication state between an electronic device, an augmented reality device, and a server according to an embodiment of the disclosure.

According to various embodiments, an electronic device 201 (e.g., the electronic device 101 in FIG. 1) may be a portable electronic device including a smartphone or a tablet PC, and may be connected to an augmented reality device 202 (e.g., the electronic device 102 or 104 in FIG. 1) through wired or wireless communication. The electronic device 201 may be electrically or functionally connected to the augmented reality device 202 through a server 203 (e.g., the server 108 in FIG. 1). The electronic device 201 may transmit and receive data (e.g., audio data, multimedia data, other control commands, and the like) to and from at least one of the augmented reality device 202 or the server 203 using a communication module (e.g., the communication module 190 in FIG. 1).

According to various embodiments, the electronic device 201 may control, at least in part, the augmented reality device 202. For example, the electronic device 201 may control the augmented reality device 202 such that a lens unit of the augmented reality device 202 displays at least one content and a user interface. According to an embodiment, the augmented reality device 202 may output a user interface based on a specific program to the lens unit in response to a command (e.g., an event) received from the electronic device 201. According to an embodiment, the electronic device 201 may control the augmented reality device 202, thereby providing the user with additional information and increasing user's convenience.

FIG. 3 is a block diagram illustrating an electronic device and an augmented reality device according to an embodiment of the disclosure.

Referring to FIG. 3, an electronic device 300 (e.g., the electronic device 101 in FIG. 1) may include a processor 301 (e.g., the processor 120 in FIG. 1), a memory 303 (e.g., the memory 130 in FIG. 1), a touch screen display 305 (e.g., the input device 150 and the display device 160 in FIG. 1), a communication module 307 (e.g., the communication module 190 in FIG. 1), a camera module 309 (e.g., the camera module 180 in FIG. 1), and a sensor module 311 (e.g., the sensor module 176 in FIG. 1). According to an embodiment, the touch screen display 305 may serve as an input device for receiving a user input, or may serve as a display device for displaying at least one content. According to an embodiment, the electronic device 300 may be electrically or functionally connected to an augmented reality device 350 (e.g., the electronic device 102 or 104 in FIG. 1) through the communication module 307, and may transmit and receive data to and from the augmented reality device 350. The augmented reality device 350 may include a processor 351, a memory 353, a lens unit 355, and a communication module 357. According to an embodiment, the augmented reality device 350 may receive a command signal from the electronic device 300, and may partially operate at least one component in response to the command signal. According to an embodiment, the augmented reality device 350 may operate the at least one component, and may simultaneously transmit feedback information according to the operation to the electronic device 300.

According to various embodiments, the electronic device 300 may transmit and receive data to and from the augmented reality device 350 through the communication module 307. The electronic device 300 may control, at least in part, at least one component included in the augmented reality device 350.

An electronic device 300 according to various embodiments may include a touch screen display 305, a communication module 307 configured to communicate with an augmented reality device 350, at least one processor 301 operably connected to the touch screen display 305 and the communication module 307, and a memory 303 operably connected to the processor 301. The memory 303 may store instructions that, when executed, allow the processor 301 to identify a connection state with the augmented reality device 350 through the communication module 307, detect an input event to the touch screen display 305 while in a connected state with the augmented reality device 350, analyze the detected input event, according to a result of the analysis, determine whether the input event is intended for at least one of a first screen based on the touch screen display 305 or a second screen corresponding to a virtual screen produced by the augmented reality device 350, and perform a function corresponding to the input event with respect to at least one of the first screen or the second screen.

According to an embodiment, the electronic device 300 may further include a camera module 309 and a sensor module 311, and the processor 301 may identify a position with respect to the augmented reality device 350 using at least one of the camera module 309 or the sensor module 311, and may determine a display area of the virtual screen produced by the augmented reality device 350.

According to an embodiment, the processor 301 may identify one or more pages constituting an application being executed, may display a first web page corresponding to a first depth, among the one or more pages, on the second screen, and may display a second web page corresponding to a second depth, among the one or more pages, on the first screen.

According to an embodiment, in response to a screenshot capturing command, the processor 301 may produce a screenshot image corresponding to the second web page displayed on the first screen, and may display the produced screenshot image on a third screen corresponding to another virtual screen.

According to an embodiment, in a case of there being a plurality of screenshot images stored in the third screen, the processor 301 may display a scroll bar at one side of the first screen, and may select at least one screenshot image from among the plurality of screenshot images using the scroll bar.

According to an embodiment, the processor 301 may duplicate the application being executed, may produce the first web page, based on the duplicated application, and may control the augmented reality device so as to display the produced first web page on the second screen.

According to an embodiment, in a case of the input event being based on a double-point input, the processor 301 may determine that the input event is intended for the second screen.

According to an embodiment, the processor 301 may select at least one content on the second screen in response to the double-point input, and may change a web page displayed on the first screen to correspond to the at least one selected content.

According to an embodiment, in a case of the input event being based on a three-point input, the processor 301 may determine that the input event is an integrated input event for the first screen and the second screen.

According to an embodiment, the input event may be configured such that the input event for the first screen is different from the input event for the second screen.

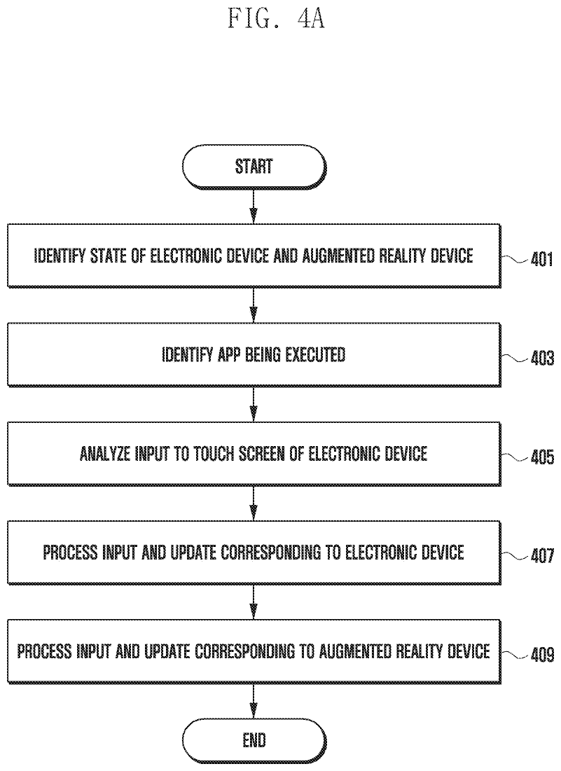

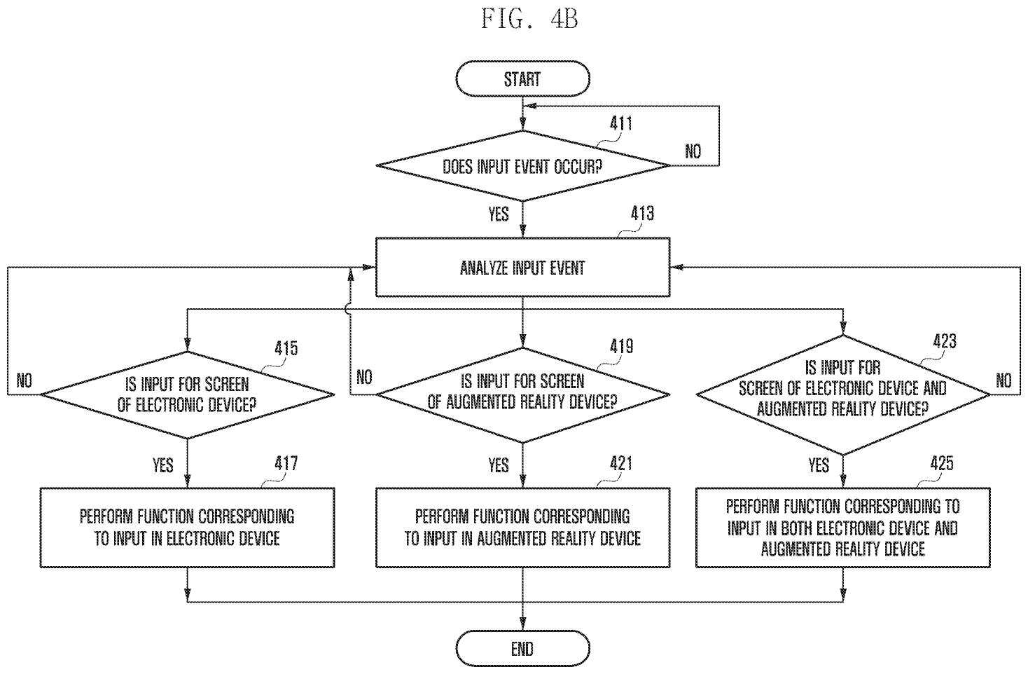

FIG. 4A is a flowchart illustrating a method of controlling an augmented reality device in an electronic device according to an embodiment of the disclosure, and FIG. 4B is a flowchart illustrating a method of controlling an augmented reality device in an electronic device according to an embodiment of the disclosure. FIG. 4A is a flowchart illustrating a method in which an electronic device controls, at least in part, an augmented reality device, and FIG. 4B is a flowchart specifically illustrating a method of processing an input event to an electronic device.

Referring to FIG. 4A, the state between an electronic device (e.g., the electronic device 300 in FIG. 3) and an augmented reality device (e.g., the augmented reality device 350 in FIG. 3) may be identified in operation 401. The electronic device 300 may be functionally connected to the augmented reality device 350 through a communication module (e.g., the communication module 307 in FIG. 3), and may identify the communication state with the augmented reality device 350 and the position of the augmented reality device 350. For example, the electronic device 300 may measure/calculate data related to the position of the augmented reality device 350, based on at least one of the camera module 309 or the sensor module 311. According to an embodiment, the electronic device 300 may identify the position of the augmented reality device 350, and, based on the arrangement structure between the electronic device 300 and the augmented reality device 350, may control, at least in part, the augmented reality device 350. For example, the augmented reality device 350 may display at least one content through a lens unit (e.g., the lens unit 355 in FIG. 3). The augmented reality device 350 may display a second screen (e.g., the display area displayed through the augmented reality device 350), which is a virtual screen, at one side of a first screen displayed on the touch screen display (e.g., the touch screen display 305 in FIG. 3) of the electronic device 300. The augmented reality device 350 may output a second screen related to at least one content included in the first screen through the lens unit 355.

According to an embodiment, based on a camera module 309 and a sensor module 311 (e.g., a depth sensor, a three-dimensional image sensor, a three-dimensional range sensor, a three-degrees-of-freedom (3 DOF) sensor, and the like), the electronic device 300 may identify the position of the augmented reality device 350. The augmented reality device 350 may identify the position of the electronic device 300, based on a camera module (e.g., the camera module 359 in FIG. 3) and a sensor module (e.g., the sensor module 361 in FIG. 3) provided in the augmented reality device 350. According to an embodiment, the electronic device 300 may determine a display area of the second screen displayed by the augmented reality device 350, based on information related to the position of the augmented reality device 350 and information related to the position of the electronic device 300. According to an embodiment, the electronic device 300 may control, at least in part, the output of the augmented reality device 350 such that the second screen is displayed at one side of the touch screen display 305. According to an embodiment, a user wearing the augmented reality device 350 may identify at least one content using the first screen based on the electronic device 300 (e.g., the touch screen display 305 of the electronic device 300) and the second screen (e.g., a virtual screen) based on the augmented reality device 350. According to an embodiment, the user may identify at least one content, based on two screens (e.g., the first screen and the second screen), thereby increasing convenience of the user.

In operation 403, a processor (e.g., the processor 301 in FIG. 3) of the electronic device 300 may identify an application being executed. According to an embodiment, the application may be an application having multiple pages and multiple depths. For example, the application may be an application implementing a user interface based on a multi-depth-based page. The application may be an application having a second page that is newly generated in response to each of a plurality of events based on a first page. In addition, the second page may generate a third page in response to each of a plurality of other events. According to an embodiment, based on a first page currently being displayed, the application may implement a second page related to the first page in response to each of a plurality of events. According to an embodiment, the processor 301 of the electronic device 300 may identify a page currently displayed on the touch screen display in relation to an application being executed.

According to various embodiments, the electronic device 300 may display a first page based on a touch screen display (e.g., the first screen), and the augmented reality device 350 may display a second page based on a virtual screen (e.g., the second screen). In the case where an application including multiple depths (e.g., a first depth and a second depth) is running, the electronic device 300 may display a second page corresponding to a first depth on the second screen, and may display a first page corresponding to a second depth on the first screen. According to an embodiment, the application may include a second page corresponding to a relatively higher depth (e.g., the first depth) and a first page corresponding to a relatively lower depth (e.g., the second depth). According to various embodiments, the electronic device 300 may display a second page corresponding to a higher depth on the virtual screen, and may display a first page corresponding to a lower depth on the touch screen display.

In operation 405, the processor 301 of the electronic device 300 may analyze an input to the touch screen display 305 of the electronic device 300. For example, the input may include 1) an input to the first screen displayed on the touch screen display 305, 2) an input to the second screen (e.g., a virtual screen) implemented from the augmented reality device 350 connected to the electronic device 300, or 3) an input both to the first screen and to the second screen. The processor 301 may determine the screen receiving the input by analyzing the input. According to an embodiment, the electronic device 300 may display the first screen through the touch screen display 305, and the augmented reality device 350 may display the second screen, which is a virtual screen, to correspond to one side of the first screen. According to an embodiment, the processor 301 may detect a user input, based on the touch screen display 305, and may determine whether the detected user input is intended for the first screen, the second screen, or both the first screen and second screen.

If the input is intended for the first screen, the processor 301 of the electronic device 300 may process the input and perform update with respect to the electronic device 300 in operation 407. For example, the processor 301 may update at least one content included in the first screen in response to the input.

If the input is intended for the second screen, the processor 301 of the electronic device 300 may process the input and perform update with respect to the augmented reality device 350 in operation 409. For example, the processor 301 may update at least one content included in the second screen in response to the input.

Referring to FIG. 4B, in operation 411, the processor 301 of the electronic device 300 may detect whether an input event occurs through the touch screen display 305. If the input event occurs in operation 411, the processor 301 may analyze the input event in operation 413. If no input event occurs in operation 411, the processor 301 may return to operation 411.

In operation 413, the processor 301 may analyze the input event. For example, the processor 301 may determine whether the input event is 1) an input to the screen (e.g., the touch screen display) of the electronic device 300, 2) an input to the screen (e.g., the virtual screen) of the augmented reality device 350, or 3) an input both to the electronic device 300 and to the augmented reality device 350. According to an embodiment, if the input event is a one-point input, the processor 301 may determine that the input event is the input to the screen of the electronic device 300 in operation 415. According to an embodiment, if the input event is a two-point input, the processor 301 may determine that the input event is the input to the screen of the augmented reality device 350 in operation 419. According to an embodiment, if the input event is a three-point input, the processor 301 may determine that the input event is the input to the electronic device 300 and the augmented reality device 350 in operation 423.

If the input is intended for the screen of the electronic device 300 in operation 415, the processor 301 may perform a function corresponding to the input in the electronic device 300 in operation 417. For example, the input may be a one-point input, and the electronic device 300 may perform a function on at least one content displayed on the screen in response to the one-point input.

If the input is intended for the screen of the augmented reality device 350 in operation 419, the processor 301 may perform a function corresponding to the input in the augmented reality device 350 in operation 421. For example, the input may be a two-point input, and the electronic device 300 may identify a first area where the two-point input is detected on the screen (e.g., the touch screen display). The electronic device 300 may identify a second area corresponding to the identified first area, based on the screen (e.g., the virtual screen) of the augmented reality device 350. According to an embodiment, the second area on the screen of the augmented reality device 350 may be positioned to correspond to the first area on the screen of the electronic device 300. For example, if the first area is positioned in the lower right area on the screen of the electronic device 300, the second area corresponding to the first area may be positioned in the lower right area on the screen of the augmented reality device 350. In operation 421, the processor 301 may perform a function on at least one content corresponding to the second area.

If the input is intended for the electronic device 300 and the augmented reality device 350 in operation 423, the processor 301 may perform a function corresponding to the input in both the electronic device 300 and the augmented reality device 350 in operation 425. For example, the input may be a three-point input, and the electronic device 300 may detect the three point input on the screen. According to an embodiment, the three-point input may be an input of dragging/swiping three touch points on the screen of the electronic device 300. According to an embodiment, the electronic device 300 may move the screen of the electronic device 300 and the screen of the augmented reality device 350 in response to the three-point input. For example, the electronic device 300 may move the first screen displayed on the touch screen display of the electronic device 300 to the display area of the augmented reality device 350 in response to the direction of the three-point input, or may move the second screen displayed on the display area of the augmented reality device 350 to the touch screen display of the electronic device 300.

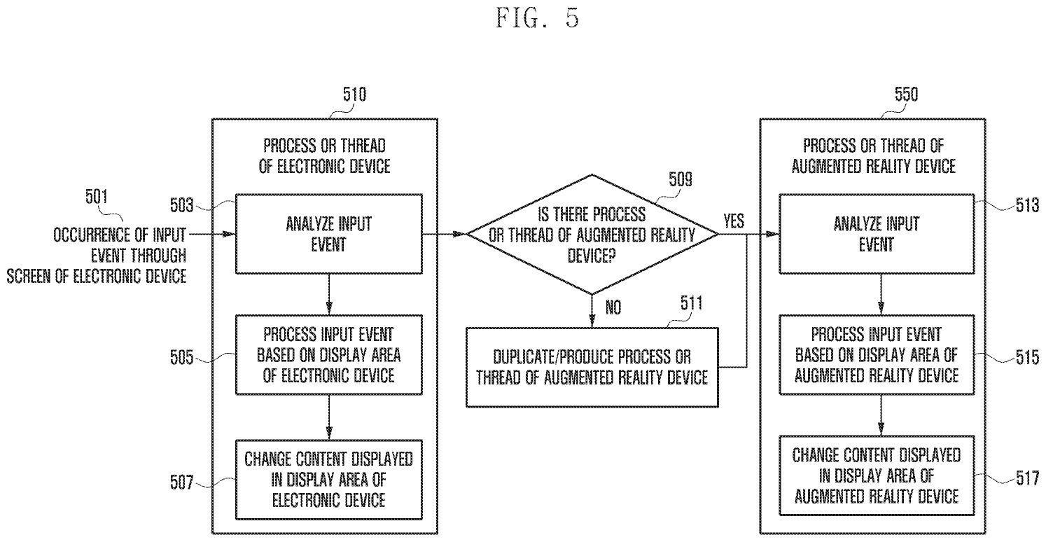

FIG. 5 is a diagram illustrating the operation of an electronic device and an augmented reality device in response to an input event according to an embodiment of the disclosure. FIG. 5 illustrates the operation of an electronic device and the operation of an augmented reality device according to an analysis of an input event and the result of the analysis of the input event.

Referring to FIG. 5, in operation 501, an input event may occur through a screen (e.g., the touch screen display 305 in FIG. 3) of an electronic device (e.g., the electronic device 300 in FIG. 3). According to an embodiment, a processor (e.g., the processor 301 in FIG. 3) of the electronic device 300 may detect the occurrence of the input event. Referring to FIG. 5, a procedure of processing a process or a thread 510 of the electronic device 300 and a procedure of processing a process or a thread 550 of an augmented reality device (e.g., the augmented reality device 350 in FIG. 3) in response to the occurrence of the input event will be described.

In operation 503, the processor 301 may analyze an input event having occurred in operation 501. The processor 301 may determine whether or not the input event corresponds to a process or a thread 510 of the electronic device. If the input event corresponds to a process or a thread 510 of the electronic device, the processor 301 may process the input event, based on the display area of the electronic device 300, in operation 505. In operation 507, the processor 301 may change at least one content displayed on the display area of the electronic device 300 in response to the input event. For example, the processor 301 may identify that the input event is intended for at least one content displayed on the touch screen display 305 of the electronic device 300, and may change at least one content displayed on the touch screen display 305 in response to the input event.

In operation 509, the processor 301 may determine whether or not the input event includes a process or a thread of an augmented reality device (e.g., the augmented reality device 350 in FIG. 3). If the input event does not include a process or a thread of the augmented reality device 350, the processor 301 may duplicate and produce a process or a thread of the augmented reality device 350 in operation 511. For example, the electronic device 300 may be in the state in which a specific application is being executed. The processor 301 may duplicate and produce the specific application in order to display the specific application on the display area of the augmented reality device 350 while the specific application is being executed. According to an embodiment, the processor 301 may duplicate a process or a thread of the augmented reality device 350, and may change at least one content displayed on the display area of the augmented reality device 350, based on the duplicated process or thread 550 of the augmented reality device 350. According to an embodiment, the processor (e.g., the processor 351 in FIG. 3) of the augmented reality device 350 may change the screen displayed on the display area of the augmented reality device, based on the duplicated process or thread 550 of the augmented reality device 350.

If the input event includes a process or a thread of the augmented reality device 350, the processor 301 may analyze the input event in operation 513, and may process the input event corresponding to the process or thread of the augmented reality device 350 in operation 515. In operation 517, the processor 301 may change at least one content displayed on the display area of the augmented reality device 350 in response to the input event.

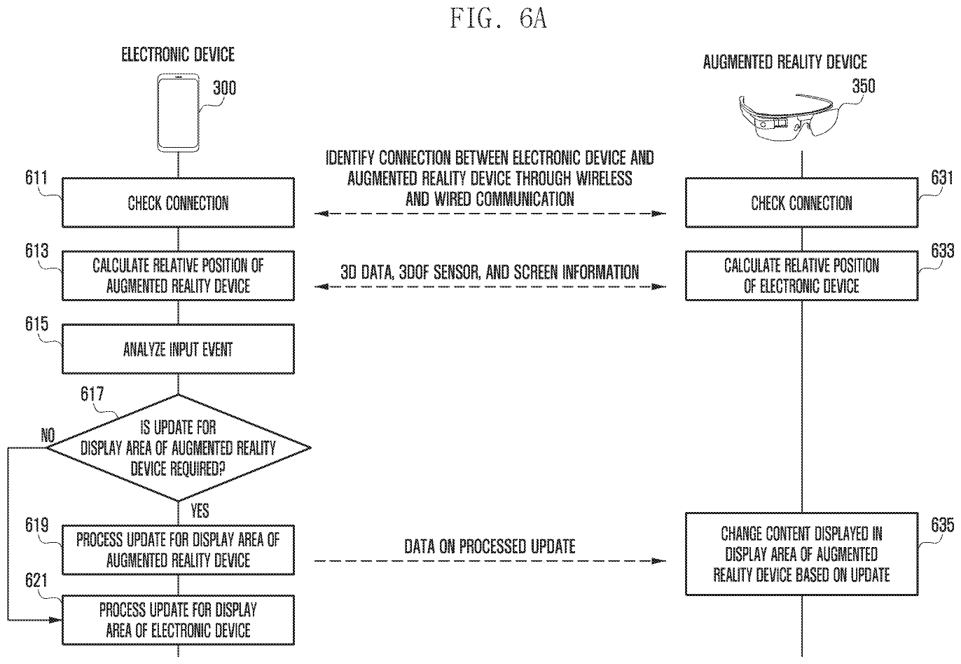

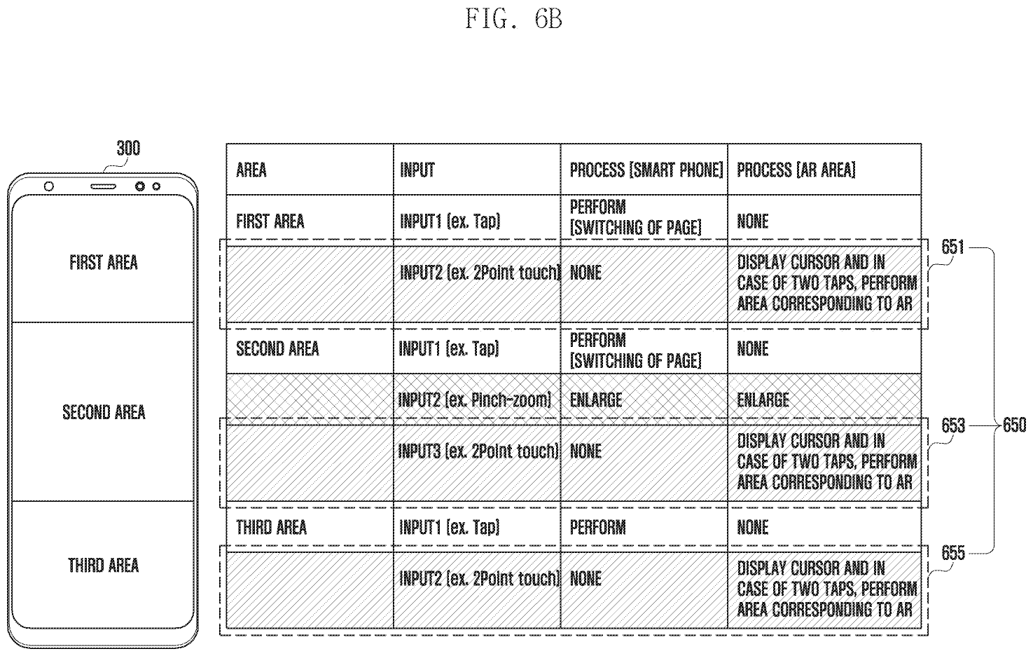

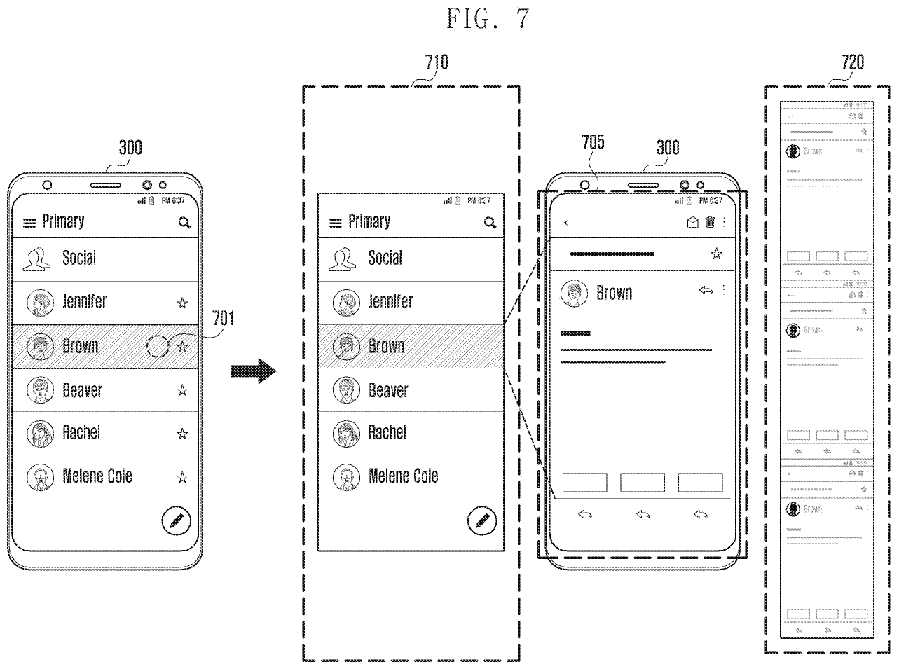

FIG. 6A is a diagram illustrating a process of transmitting and receiving data between an electronic device and an augmented reality device according to an embodiment of the disclosure, and FIG. 6B is a diagram illustrating a process of transmitting and receiving data between an electronic device and an augmented reality device according to an embodiment of the disclosure. FIG. 6A illustrates a time table in which data is transmitted and received between the electronic device 300 and the augmented reality device 350, and FIG. 6B is a table illustrating processing corresponding to a process or a thread of the electronic device 300 and processing corresponding to a process or a thread of the augmented reality device 350 by analyzing an input event.

Referring to FIG. 6A, a processing procedure (e.g., a process or a thread) in each of the electronic device 300 and the augmented reality device 350 while the electronic device 300 and the augmented reality device 350 perform communication will be described. In operation 611, the electronic device 300 may check the connection state with the augmented reality device 350 that is connected through wireless or wired communication. In operation 631, the augmented reality device 350 may check the connection state with the electronic device 300 that is connected through wireless or wired communication. According to an embodiment, the electronic device 300 and the augmented reality device 350 may identify the communication state therebetween.

In operation 613, the electronic device 300 may calculate a relative position of the augmented reality device 350. According to an embodiment, the electronic device 300 may calculate a relative position of the augmented reality device 350 using a camera module (e.g., the camera module 309 in FIG. 3) and a sensor module (e.g., the sensor module 311 in FIG. 3). For example, the electronic device 300 may identify a relative position of the augmented reality device 350, based on 3D data and screen information. According to an embodiment, in operation 633, the augmented reality device 350 may calculate a relative position of the electronic device 300 using a camera module (e.g., the camera module 359 in FIG. 3) and a sensor module (e.g., the sensor module 361 in FIG. 3). For example, the augmented reality device 350 may identify a relative position of the electronic device 300, based on 3D data and screen information. According to an embodiment, the electronic device 300 and the augmented reality device 350 may identify position information with each other, and transmit and receive the identified position information to and from each other.

In operation 615, the electronic device 300 may detect an input event through the touch screen display (e.g., the touch screen display 305 in FIG. 3), and may analyze the input event. According to an embodiment, the analysis of the input event may be a process of determining whether the input event is 1) an input to the screen (e.g., the touch screen display) of the electronic device 300, 2) an input to the screen (e.g., a virtual screen) of the augmented reality device 350, or 3) an input to the electronic device 300 and the augmented reality device 350. The process of analyzing the input event may refer to the description made above with reference to FIG. 4B, which will be omitted here.

In operation 617, the electronic device 300 may determine whether or not to update the display area (e.g., a virtual screen) of the augmented reality device 350. For example, if the input event detected in operation 615 is an input to the augmented reality device 350, the display area of the augmented reality device 350 may be updated in response to the input event.

If the display area of the augmented reality device 350 is to be updated in operation 617, the electronic device 300 may process the update of the display area of the augmented reality device 350 in operation 619. For example, the electronic device 300 may transmit data related to the update to the augmented reality device 350, and the augmented reality device 350 may receive the transmitted update-related data. In operation 635, the augmented reality device 350 may change at least one content displayed on the display area of the augmented reality device 350, based on the received update-related data.

In operation 621, the electronic device 300 may process update of the display area (e.g., the touch screen display) of the electronic device 300. For example, the electronic device 300 may change at least one content displayed on the display area of the electronic device 300.

FIG. 6B illustrates a reference table for determining whether an input event is a process and a thread for the electronic device 300 or a process and a thread for the augmented reality device 350.

Referring to FIG. 6B, the electronic device 300 may divide a screen (e.g., the touch screen display 305 in FIG. 3) into one or more areas (e.g., a first area, a second area, and a third area). According to an embodiment, the electronic device 300 may detect an input event through a screen, and may perform a process or a thread corresponding to the one or more areas in response to the input event.

According to an embodiment, the electronic device 300 may detect a first input (e.g., a tap input) or a second input (e.g., a two-point input) in the first area. For example, the first input may be an input for a process and a thread of the electronic device 300, and the second input may be an input 651 for a process and a thread of the augmented reality device 350. According to an embodiment, if the first input is detected in the first area, the electronic device 300 may execute at least one function (e.g., switching of a page) with respect to the electronic device 300. According to an embodiment, if the second input is detected in the first area, the electronic device 300 may display at least one function with respect to the augmented reality device 350 (e.g., displaying a cursor to correspond to the position in which the second input is dedicated, based on the display area of the augmented reality device 350, and if two taps are input, performing a function corresponding to the displayed cursor).

According to an embodiment, the electronic device 300 may receive a first input (e.g., a tap input), a second input (e.g., a pinch-zoom input), or a third input (e.g., a two-point input) in the second area. For example, the first input may be an input for a process and a thread of the electronic device 300, and the second input may be an integrated input for the electronic device 300 and the augmented reality device 350. The third input may be an input 653 for a process and a thread of the augmented reality device 350. The first input may be the same as the first input in the first area described above, and the third input may be the same as the second input in the first area described above. According to an embodiment, if the second input is detected in the second area, the electronic device 300 may execute a function (e.g., enlarging) with respect to at least one of the electronic device 300 or the augmented reality device 350.

According to an embodiment, the electronic device 300 may detect a first input (e.g., a tap input) or a second input (e.g., a two-point input) in the third area. For example, the first input may be an input for a process and a thread of the electronic device 300, and the second input may be an input 655 for a process and a thread of the augmented reality device 350. The first input may be the same as the first input in the first area described above, and the second input may be the same as the second input in the first area described above.

According to various embodiments, the electronic device 300 may select and perform at least one input (e.g., a first input, a second input, or a third input) according to the connection state with the augmented reality device 350. For example, if the electronic device 300 is in connection with the augmented reality device 350, the electronic device 300 may determine whether the touch event is an input corresponding to a process and a thread for the electronic device 300 or an input 650 corresponding to a process and a thread for the augmented reality device 350, and according to the determination, a process and a thread with respect to at least one of the electronic device 300 or the augmented reality device 350 may be performed.

According to various embodiments, an input may be redefined according to the connection state between the electronic device 300 and the augmented reality device 350, and the electronic device 300 perform an input event, based on the redefined input. An input to the display area of the electronic device 300 and the input to the display area of the augmented reality device 350 may be independently redefined according to the connection state between the electronic device 300 and the augmented reality device 350.

FIG. 7 is a diagram illustrating a screen provided to a user, based on an electronic device and an augmented reality device according to an embodiment of the disclosure.

Referring to FIG. 7, an electronic device (e.g., the electronic device 300 in FIG. 3) may be in an electrically or functionally connected state with an augmented reality device (e.g., the augmented reality device 350 in FIG. 3). The processor (e.g., the processor 301 in FIG. 3) of the electronic device 300 may display a contact list, based on the touch screen display (e.g., the touch screen display 305 in FIG. 3). The processor 301 may detect an input event 701 for the contact list.

According to various embodiments, the electronic device 300 may display an application through the touch screen display 305, and the display area corresponding to the touch screen display 305 may include a first screen 705. According to an embodiment, the electronic device 300 may display at least one content on the first screen 705. The augmented reality device 350 may output an application through a virtual screen, and the display area corresponding to the virtual screen may include a second screen 710 and a third screen 720. According to various embodiments, the processor 301 may display an application being executed based on the first screen 705, the second screen 710, and the third screen 720 in response to the detected input event 701.

According to various embodiments, the application may include multiple depths (e.g., a first depth and a second depth). According to an embodiment, the processor 301 may display a contact list corresponding to the first depth, and may detect an input event 701 for the contact list. The processor 301 may display a contact list corresponding to the first depth on the second screen 710 in response to the input event 701, and may display specific contact information according to the input event 701 on the first screen 705. According to an embodiment, the processor 301 may display a third screen 720 corresponding to another virtual screen, and the third screen 720 may include at least one screenshot image. Images included in the third screen 720 may be stored in sequence, based on configuration information.

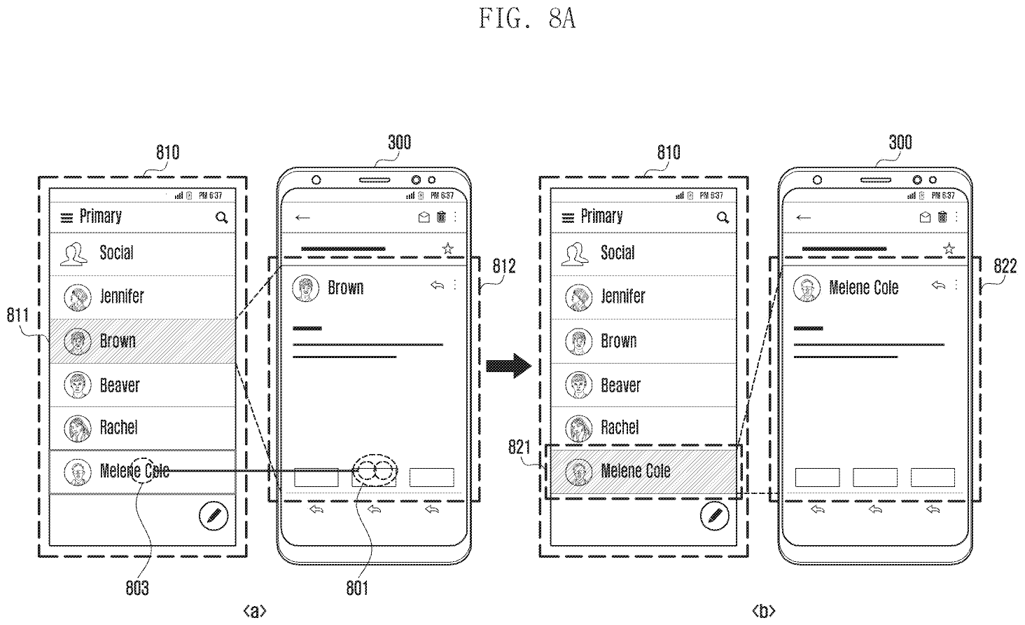

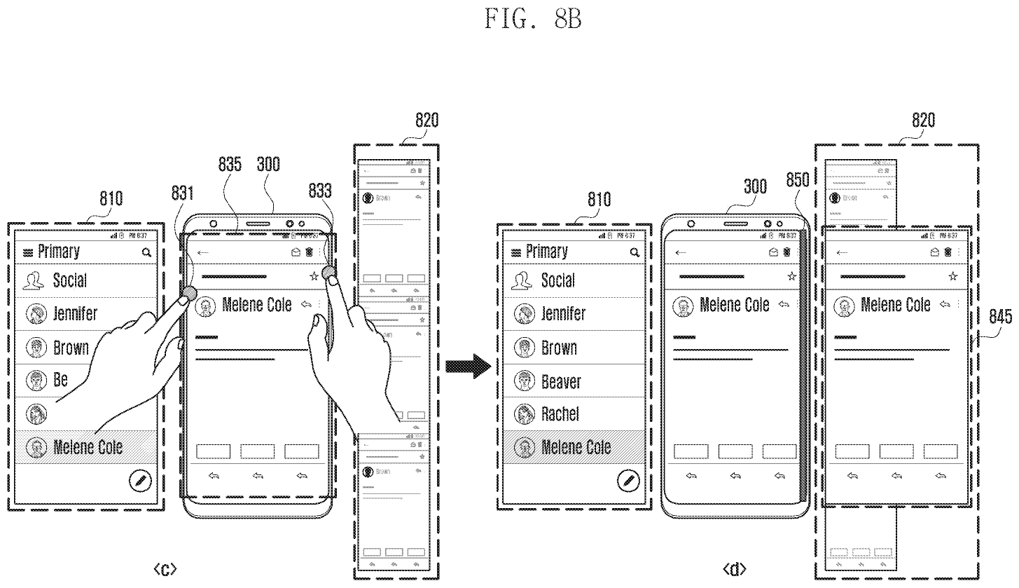

FIG. 8A is a diagram illustrating an embodiment of controlling, at least in part, an augmented reality device using an electronic device according to an embodiment of the disclosure, and FIG. 8B is a diagram illustrating an embodiment of controlling, at least in part, an augmented reality device using an electronic device according to an embodiment of the disclosure.

Referring to <a> in FIG. 8A, a contact list 811 corresponding to the first depth may be displayed on the second screen 810 displayed through the augmented reality device 350, and detailed information about one of the contact list 811 may be displayed in the first screen 812 displayed through the touch screen display. For example, if “Brown” is selected from among the contacts included in the contact list 811, the electronic device 300 may display detailed information of “Brown” through the touch screen display. According to various embodiments, the electronic device 300 may detect a two-point input 801, and may determine that the detected two-point input 801 is intended for the second screen 810 displayed through the augmented reality device 350. For example, if the two-point input 801 is detected, the processor 301 of the electronic device 300 may identify the position of the area where the two-point input 801 is detected, and may determine the position of the identified area, based on the second screen 810. According to an embodiment, the processor 301 may determine at least one content on the second screen 810 corresponding to the position of the determined area, and may perform the function corresponding to the at least one content. For example, the processor 301 may select “Melene Cole” 803 that is a contact corresponding to the position of the determined area.

Referring to <b> in FIG. 8A, “Melene Cole” may be selected from the second screen 810 displayed through the augmented reality device 350, and the processor 301 may display that “Melene Cole” was selected (821). The processor 301 may select one contact from the contact list displayed on the second screen 810, and may display detailed information on the selected one contact (e.g., “Melene Cole”) on the first screen 822. According to an embodiment, the processor 301 may change a color of the contact selected from the contact list included in the second screen 810, and the user may identify the selected contact, based on the changed color.

According to various embodiments, the processor 301 of the electronic device 300 may display an application, based on a first screen 812 or 822 corresponding to the touch screen display and a second screen 810 corresponding to a virtual screen implemented by the augmented reality device 350. According to an embodiment, the application may be configured based on a multi-depth. According to an embodiment, the processor 301 may display a first web page corresponding to a higher depth (e.g., the first depth) to correspond to the second screen 810, and may display a second web page corresponding to a lower depth (e.g., a second depth) to correspond to the first screen 812. According to an embodiment, the processor 301 may display a third web page corresponding to a third depth in response to an input event for the second web page corresponding to the second depth, and the second web page may be moved to and displayed on the second screen 810 corresponding to a virtual screen.

Referring to <c> in FIG. 8B, the processor 301 of the electronic device 300 may display a first virtual screen (e.g., the second screen 810 in FIG. 8A) and a second virtual screen 820 (e.g., the third screen) through the augmented reality device 350. For example, a contact list may be displayed on the first virtual screen 810, and one or more screenshot images may be displayed on the second virtual screen 820. According to an embodiment, the processor 301 may display a contact list corresponding to the first depth through the first virtual screen 810, and the processor 301 may display detailed information on at least one contact corresponding to the second depth through the first screen 835 corresponding to the touch screen display of the electronic device 300. According to an embodiment, the processor 301 may display one or more screenshot images in a predetermined order through the second virtual screen 820. According to an embodiment, the processor 301 may store the first screen 835 as a screenshot image in response to a screenshot capturing command For example, the screenshot capturing command may occur if physical buttons 831 and 833 provided in the electronic device 300 are simultaneously pressed. According to an embodiment, the screenshot capturing command is not limited to an input of the physical buttons, and may be configured in any of various ways.

Referring to <d> in FIG. 8B, the processor 301 may produce a screenshot image 845 of the first screen 835 in response to the screenshot capturing command, and may display the screenshot image 845 in the central area of the second virtual screen 820. According to an embodiment, if there are a plurality of screenshot images 845 displayed on the second virtual screen 820, the electronic device 300 may produce a scroll bar 850 for selecting the screenshot images 845 at one side of the first screen 835. According to an embodiment, the processor 301 may determine a screenshot image to be displayed in the central area of the second virtual screen 820, based on the scroll bar 850, and may display the determined screenshot image to be relatively large in the central area of the second virtual screen 820.

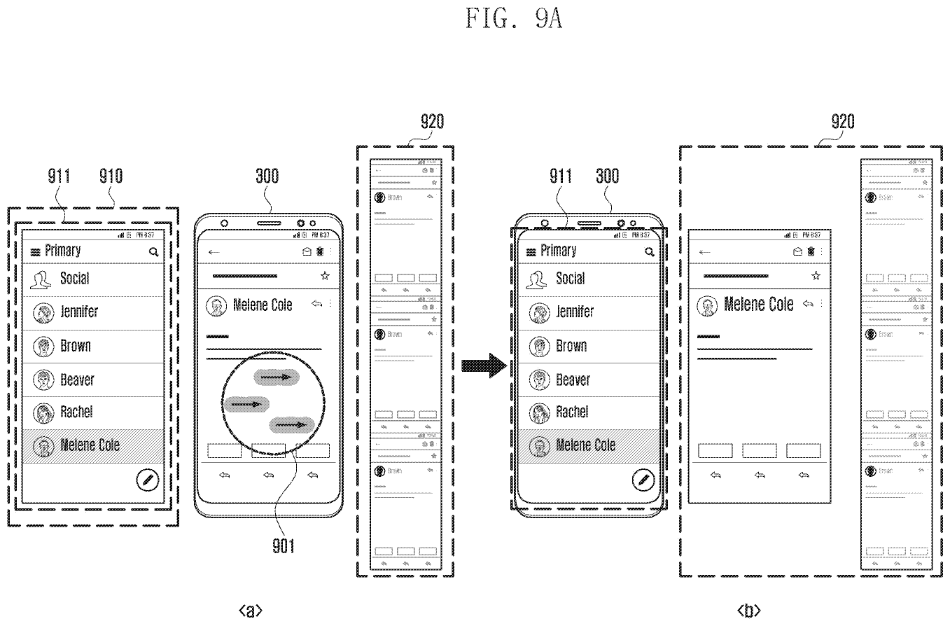

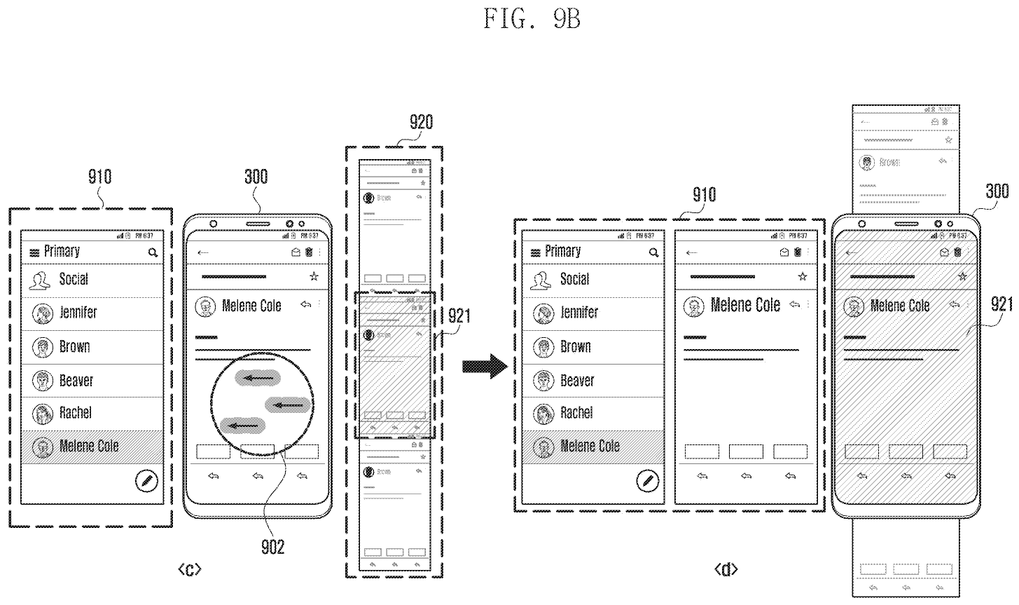

FIG. 9A is a diagram illustrating an embodiment of displaying a screen by an augmented reality device using an electronic device according to an embodiment of the disclosure, and FIG. 9B is a diagram illustrating an embodiment of displaying a screen by an augmented reality device using an electronic device according to an embodiment of the disclosure.

Referring to <a> in FIG. 9A, a contact list 911 corresponding to a first depth may be displayed on a second screen 910 displayed through the augmented reality device 350, and detailed information on one contact (e.g., “Melene Cole”) selected from the contact list 911 may be displayed on a first screen displayed through the touch screen display of the electronic device 300. In addition, one or more screenshot images may be displayed on a third screen 920 displayed through the augmented reality device 350. According to various embodiments, the electronic device 300 may detect a three-point input 901, and the detected three-point input 901 may be a drag and swipe input. For example, the processor 301 of the electronic device 300 may detect a three-point input 901 moving from the left to the right of the electronic device 300.

Referring to <b> in FIG. 9A, the processor 301 may move the detailed information of the contact displayed on the first screen to the third screen 920 in response to the detected three-point input 901, and may move and display the contact list displayed on the second screen 910 to and on the first screen. According to an embodiment, the processor 301 may store the detailed information of the contact as a screenshot image in response to the three-point input 901, and may move the stored screenshot image to the third screen 920. According to an embodiment, the processor 301 may display one or more screenshot images on the third screen 920.

Referring to <c> in FIG. 9B, the electronic device 300 may detect a three-point input 902, and the detected three point input 902 may be a drag and swipe input. For example, the processor 301 of the electronic device 300 may detect a three-point input 902 moving from the right to the left of the electronic device 300.

Referring to <d> in FIG. 9B, in response to the detected three-point input 902, the processor 301 may move and display the detailed information of the contact displayed on the first screen to and on the second screen 910, and may move and display one or more screenshot images displayed on the third screen 920 to and on the first screen. According to an embodiment, the processor 301 may display a screenshot image 921 positioned in the central area, among the one or more screenshot images, to correspond to the first screen. According to an embodiment, the processor 301 may partially control the augmented reality device 350 so as to display the second screen 910 and the third screen 920 corresponding to virtual screens.

A method for operating an electronic device 300 according to various embodiment may include: identifying a connection state with the augmented reality device 350; detecting an input event to the touch screen display 305 while in a connected state with the augmented reality device 350; analyzing the detected input event; according to a result of the analysis, determining whether the input event is intended for at least one of a first screen based on the touch screen display 305 or a second screen corresponding to a virtual screen produced by the augmented reality device 350; and performing a function corresponding to the input event with respect to at least one of the first screen or the second screen.

According to an embodiment, the operation of identifying the connection state with the augmented reality device 350 may include: identifying a position with the augmented reality device 350 using at least one of a camera module 309 or a sensor module 311; and determining a display area of the virtual screen produced by the augmented reality device 350.

According to an embodiment, the method may further include: identifying one or more pages constituting an application being executed; displaying a first web page corresponding to a first depth, among the one or more pages, on the second screen; and displaying a second web page corresponding to a second depth, among the one or more pages, on the first screen.

According to an embodiment, the method may further include: in response to a screenshot capturing command, producing a screenshot image corresponding to the second web page displayed on the first screen; and displaying the produced screenshot image on a third screen corresponding to another virtual screen.

According to an embodiment, the method may further include: in a case of there being a plurality of screenshot images stored in the third screen, displaying a scroll bar at one side of the first screen; and selecting at least one screenshot image from among the plurality of screenshot images using the scroll bar.

According to an embodiment, the operation of displaying on the second screen may include: duplicating the application being executed; producing the first web page, based on the duplicated application; and controlling the augmented reality device so as to display the produced first web page on the second screen.

According to an embodiment, the operation of determining whether the input event is intended for the second screen may include, in a case of the input event being based on a double-point input, determining that the input event is intended for the second screen.

According to an embodiment, the method may further include: selecting at least one content on the second screen in response to the double-point input; and changing a web page displayed on the first screen to correspond to the at least one selected content.

According to an embodiment, the operation of determining whether the input event is intended for the second screen may include, in a case of the input event being based on a three-point input, determining that the input event is an integrated input event for the first screen and the second screen.

According to an embodiment, the input event may be configured such that the input event for the first screen is different from the input event for the second screen.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a non-transitory machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a touch screen display;
a communication module configured to communicate with an augmented reality device;
a memory; and
at least one processor operably connected to the touch screen display, the communication module, and the memory,
wherein the memory stores instructions that, when executed by the processor, cause the at least one processor to:
identify a connection state with the augmented reality device through the communication module;
detect an input event to the touch screen display while in a connected state with the augmented reality device;
analyze the detected input event;
according to a result of the analysis, determine whether the input event is intended for at last one of a first screen based on the touch screen display or a second screen corresponding to a virtual screen produced by the augmented reality device; and
perform a function corresponding to the input event with respect to at least one of the first screen or the second screen.

2. The electronic device of claim 1, further comprising:
a camera module; and
a sensor module,
wherein the instructions, when executed by the processor, further cause the at least one processor to:
identify a position with the augmented reality device using at least one of the camera module or the sensor module; and
determine a display area of the virtual screen produced by the augmented reality device.

3. The electronic device of claim 1, wherein the instructions, when executed by the processor, further cause the at least one processor to:
identify one or more pages constituting an application being executed;
display a first web page corresponding to a first depth, among the one or more pages, on the second screen; and
display a second web page corresponding to a second depth, among the one or more pages, on the first screen.

4. The electronic device of claim 3, wherein the instructions, when executed by the processor, further cause the at least one processor to:
in response to a screenshot capturing command, produce a screenshot image corresponding to the second web page displayed on the first screen; and
display the produced screenshot image on a third screen corresponding to another virtual screen.

5. The electronic device of claim 4, wherein the instructions, when executed by the processor, further cause the at least one processor to:
in a case of there being a plurality of screenshot images stored in the third screen, display a scroll bar at one side of the first screen; and
select at least one screenshot image from among the plurality of screenshot images using the scroll bar.

6. The electronic device of claim 3, wherein the instructions, when executed by the processor, further cause the at least one processor to:
duplicate the application being executed;
produce the first web page, based on the duplicated application; and
control the augmented reality device so as to display the produced first web page on the second screen.

7. The electronic device of claim 1, wherein the instructions, when executed by the processor, further cause the at least one processor to, in a case of the input event being based on a double-point input, determine that the input event is intended for the second screen.

8. The electronic device of claim 7, wherein the instructions, when executed by the processor, further cause the at least one processor to:
select at least one content on the second screen in response to the double-point input; and
change a web page displayed on the first screen to correspond to the at least one selected content.

9. The electronic device of claim 1, wherein the instructions, when executed by the processor, further cause the at least one allow the processor to, in a case of the input event being based on a three-point input, determine that the input event is an integrated input event for the first screen and the second screen.

10. The electronic device of claim 1, wherein the input event is configured such that the input event for the first screen is different from the input event for the second screen.

11. A method for operating an electronic device, the method comprising:
identifying a connection state with the augmented reality device;
detecting an input event to the touch screen display while in a connected state with the augmented reality device;
analyzing the detected input event;
according to a result of the analysis, determining whether the input event is intended for at least one of a first screen based on the touch screen display or a second screen corresponding to a virtual screen produced by the augmented reality device; and
performing a function corresponding to the input event with respect to at least one of the first screen or the second screen.

12. The method of claim 11, wherein the identifying of the connection state with the augmented reality device comprises:
identifying a position with the augmented reality device using at least one of a camera module or a sensor module; and
determining a display area of the virtual screen produced by the augmented reality device.

13. The method of claim 11, further comprising:
identifying one or more pages constituting an application being executed;
displaying a first web page corresponding to a first depth, among the one or more pages, on the second screen; and
displaying a second web page corresponding to a second depth, among the one or more pages, on the first screen.

14. The method of claim 13, further comprising:
in response to a screenshot capturing command, producing a screenshot image corresponding to the second web page displayed on the first screen; and
displaying the produced screenshot image on a third screen corresponding to another virtual screen.

15. The method of claim 14, further comprising:
in a case of there being a plurality of screenshot images stored in the third screen, displaying a scroll bar at one side of the first screen; and
selecting at least one screenshot image from among the plurality of screenshot images using the scroll bar.

16. The method of claim 13, wherein the displaying on the second screen comprises:
duplicating the application being executed;
producing the first web page, based on the duplicated application; and
controlling the augmented reality device so as to display the produced first web page on the second screen.

17. The method of claim 11, wherein the determining of whether the input event is intended for the second screen comprises, in a case of the input event being based on a double-point input, determining that the input event is intended for the second screen.

18. The method of claim 17, further comprising:
selecting at least one content on the second screen in response to the double-point input; and
changing a web page displayed on the first screen to correspond to the at least one selected content.

19. The method of claim 11, wherein the determining of whether the input event is intended for the second screen comprises, in a case of the input event being based on a three-point input, determining that the input event is an integrated input event for the first screen and the second screen.

20. The method of claim 11, wherein the input event is configured such that the input event for the first screen is different from the input event for the second screen.
